(19) United States
(12) Patent Application Publication
(10) Pub. No.: US 2010/0127467 A1
(43) Pub. Date: May 27, 2010

(54) Snowmobile ski runner and method of manufacture

(76) Inventor: Michael A. Phillips, Gladwin, MI (US)

Correspondence Address: MCKELLAR IP LAW, PLLC, 784 SOUTH POSEYVILLE ROAD, MIDLAND, MI, 48640, US

(21) Appl. No.: 12/590,918

(22) Filed: Nov. 16, 2009

Related U.S. Application Data
(60) Provisional application No. 61/200,320, filed on Nov. 26, 2008.

(51) Int. Cl. B62B 17/02; B23P 11/00

(52) U.S. Cl. 280/28; 29/428

(57) ABSTRACT

Traction enhancing runner assemblies for mounting underneath a snowmobile ski. The runner assemblies of this invention are a single rail with double edges to provide parallel runner bars, but the runner bars are not adjacent each other such that they provide a “staggered” runner arrangement which enhances the traction of the runner bar and hence the stability of the snowmobile on which they are mounted. Also, the double edges are provided with novel grooves that contain hard welds or carbide inserts to enhance the wear characteristics of the runner assemblies.

This application claims priority from US Provisional patent application No. 61/200,320 filed Nov. 26, 2008.

### BACKGROUND OF THE INVENTION

The invention disclosed and claimed herein deals with traction enhancing runner assemblies for mounting underneath a snowmobile ski. The runner assemblies of this invention are novel owing to the fact that they have parallel runner bars, but the runner bars are not adjacent each other such that they provide a “staggered” runner arrangement which enhances the traction of the runner bar and hence the stability of the snowmobile on which they are mounted. Since the runner assemblies are formed from a single sheet metal, the resulting runner is a single rail with a double edge.

In addition, the runner bars have long longitudinal grooves in their ground contacting free edges and there are hardened carbide wear strips securely mounted in these grooves to enhance the durability of the runner bars.

Also described herein are unique manufacturing methods for manufacturing the runner assemblies of this invention.

### THE INVENTION

Thus, there is disclosed herein a traction enhancing runner assembly for mounting on the underside of a snowmobile ski. The runner assembly comprises a runner body fabricated from a single piece of metal having a predetermined hardness. The runner body has a central portion with an upper surface, a lower surface, a near end, and a distal end. The central body has integrally attached thereto a transversely downwardly projecting pair of runners which terminate at lower free edges.

The pair of runners comprises a first runner and a second runner and the first runner and the second runner have longitudinal grooves the length of their free edges. The first runner and second runners are not adjacent to each other and thus form staggered runners.

There is a mounting means secured to and projecting upwardly from the upper surface of the runner body, wherein the mounting means is operative to mount the runner assembly on the underside of a snowmobile ski. Finally, the distal end of the runner body is bent upwardly in a ski form.

In a second embodiment, there is a traction enhancing runner assembly for mounting on the underside of a snowmobile ski comprising a runner body fabricated from a single piece of metal having a predetermined hardness wherein said runner body has a central portion with an upper surface, a lower surface, a near end, and a distal end and said central body has integrally attached thereto a transversely downwardly projecting pair of runners which terminate at lower free edges.

The pair of runners comprises a first runner and a second runner, the first runner and the second runner have longitudinal grooves the length of the free edges in which carbide wear strips are attached at predetermined locations in the longitudinal grooves.

The first runner and said second runner are not adjacent to each other thereby form staggered runners. The first runner and second runner have hardened welds along the free lower edges thereof, at predetermined locations.

There is a mounting means secured to and projecting upwardly from the upper surface of the runner body, the mounting means being operative to mount the runner on the underside of the snowmobile ski. The distal end of the runner body is bent upwardly in a ski form.

In another embodiment, there is a method of fabricating a runner assembly for mounting on the underside of a snowmobile ski comprising providing a single, generally planer sheet of metal material having a predetermined hardness, a generally uniform thickness, upper and lower surfaces, generally free edges the length of the metal material, and longitudinal grooves in said free edges.

Thereafter, a desired shaped workpiece is separated from the planer sheet. The shaped workpiece is then bent into a predetermined first runner portion and a predetermined second runner portion side regions of the shaped workpiece out of the plane of the workpiece to extend each runner portion transversely downwardly.

Mounting portions are then formed on the base portion and these mounting portions project upwardly from the top surface of the base portion and do not extend into the area between the runner portions.

### BRIEF DESCRIPTION OF THE DRAWINGS

FIG. 1A is a full top view of a single planer sheet of metal material showing the grooved edges in phantom.

FIG. 1B is a full end view of the single planer sheet of FIG. 1A.

FIG. 2 is a full top view of the single planer sheet of metal of FIG. 1 after it has been shaped into the desired shape.

FIG. 3A is a full side view of the shaped metal of FIG. 2 after it has been bent.

FIG. 3B is a full end view of the bent shaped metal of FIG. 3A showing angle □ of 90°.

FIG. 3C is a full end view of the bent shaped metal of FIG. 3A showing angle □ of 105°.

FIG. 4 is a full side view of the bent shaped metal of FIG. 3A after the distal end has been bent upwardly.

FIG. 5 is a full side view of the bent shaped metal of FIG. 4 showing the mounting hardened carbide wear strips in the longitudinal grooves.

FIG. 6 is a full side view of the bent shaped metal of FIG. 5 showing the mounting means mounted on the upper surface of the device.

FIG. 7 is an end view of a bent shaped metal runner showing one edge of the runner longer than the other edge of the runner.

### DETAILED DESCRIPTION OF THE INVENTION

This invention has the advantage of the staggered runners in the longitudinal direction of the runner to enhance traction for a snowmobile while stabilizing the snowmobile against darting and erratic motion. The invention further has the advantage of maintaining the underside of the runner assembly open and free of any mounting structures which could otherwise serve to entrap rocks and other debris within the channel or damage the mounting hardware, for example, weakening or shearing off a bolt head or the like.

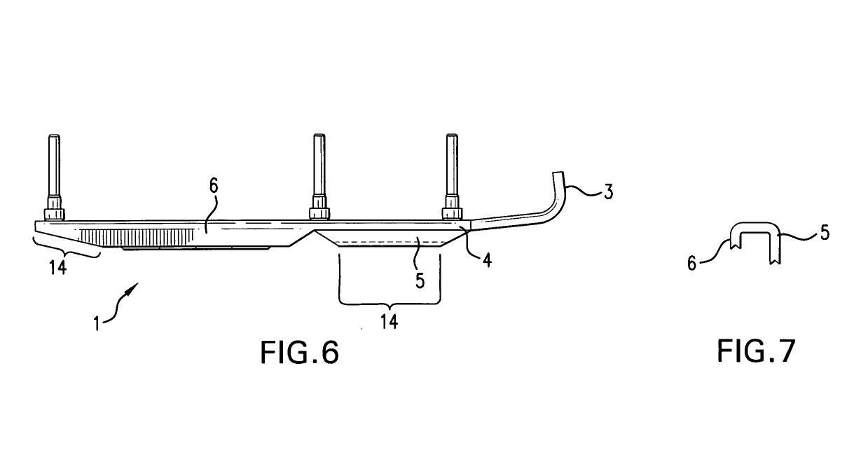

FIG. 6 is a full side view of a device 1 of this invention in which there is shown mounting means 2, bent distal end 3 of a central body 4, along with a first runner 5 and a second runner 6, and hardened carbide wear strips 7. In FIG. 7, the runner 5 is longer in a downward direction than the runner 6.

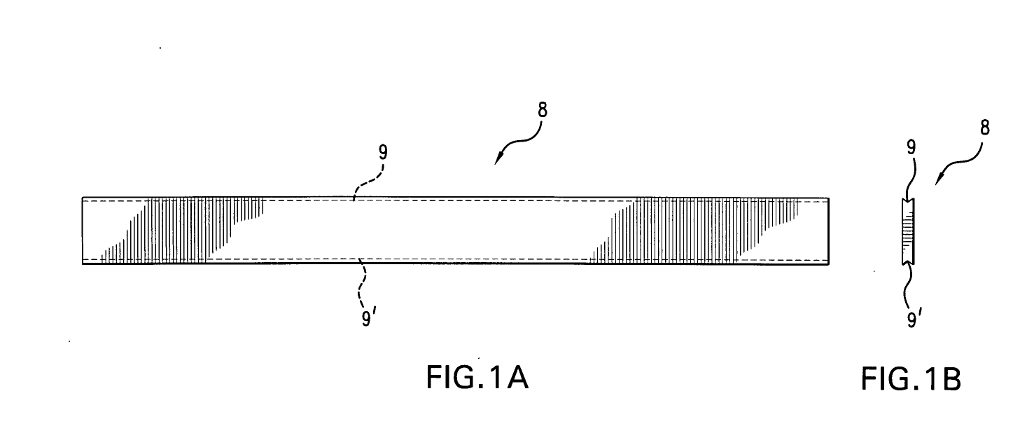

Turning now to FIG. 1A which is a full top view of a single planer sheet of metal material 8 showing the grooved edges 9 and 9′ in phantom and FIG. 1B which is a full end view of the single planer sheet of FIG. 1A such that the grooves 9 and 9′ can be more readily observed.

The stock material may be fabricated of steel, such as a low carbon plain steel like SAE 1018, or could be manufactured from medium (SAE 1045) or high carbon (SAE 1090) steels or spring grade or stainless steel alloys, to name a few, as well as from non-ferrous materials such as aluminum or its alloys, making adjustability of runner changes easy and cost effective.

The sheet material is stamped or cut with a stamping machine having a cutting die with an outline on forming to the outline of the workpiece to provide the general outline of the interim workpiece 10 which is subsequently bent to form the runner body 4 and adjacent runners 5 and 6.

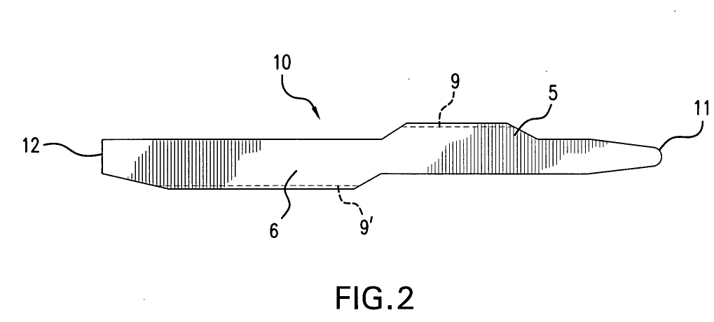

FIG. 2 is a full top view of the single planer sheet of metal of FIG. 1 after it has been shaped into the desired shape 10, such as by stamping or some other convenient means. Note that there is a conventional narrowing of the distal end 11 of the single planer sheet and also that the near end 12 has been configured to alleviate a runner at the tail end of the runner assembly.

Shown in the FIG. 2 is the first runner 5 and the second runner 6 before they have been bent transversely downwardly. Shown also in the Figure are the grooves 9 and 9′. It should be recognized that after the first runner 5 and the second runner 6 have been bent downwardly, they are parallel but not adjacent to each other. Thus, in this manner they form “staggered” runners. It does not matter whether first runner 5 is on the inside or the outside and also, it does not matter if the second runner 6 is on the inside or vice versa, as long as they are staggered and are not formed adjacent to each other. It should be noted that the lack of runners in certain portions of the runner assembly aid the runner in ridding itself of debris and other materials that may lodge or jam in between standard double runner pairs of the prior art.

It should be noted that the staggered runners 5 and 6 are thus integrally joined with the central body 4 all in one piece because of the bending of a single piece of metal, and are not welded to the central body as are many of the prior art dual runners. The staggered runners 5 and 6 are useful in providing enhanced traction for the snowmobile they are mounted on, but they also cut down on the hard grabbing duel runners of the prior art and allow for less darting and erratic motion of the front end of the snowmobile. It should be noted that one of these runners can be shorter than the other of the runners.

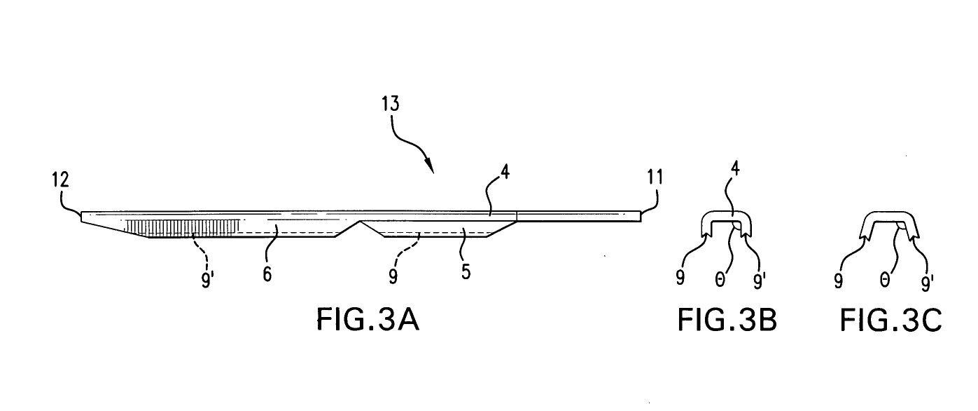

FIG. 3A is a full side view of the shaped metal sheet after it has been bent 13 into the staggered runners. Shown is the near end 12, the distal end 11, the central runner body 4, first runner 5, and second runner 6. FIG. 3B is a full end view of the shaped metal sheet 13.

The angles formed by the bent portions of runners 5 and 6 can be at or about 90° from the plane of the base portion 4, or they can be greater angles, up to about 130°, but it is preferred to be less than 125°, and most preferable about 105°, or less. Said angles are inside angles □ as set forth in FIGS. 3B and 3C.

The height of the bent portion 5 and 6 can vary depending on the end use. Heights of about ½ inch to less tend to provide less pull of the ski and would tend to be used on recreational vehicles, while heights of more than ½ inch would tend to be used on racing vehicles and the like. Preferred would be a height of about ¾ inches. Also, the two bent portions 5 and 6 do not have to have the same height on the same runner, although, it is preferred that they are nearly equivalent in height on the same runner.

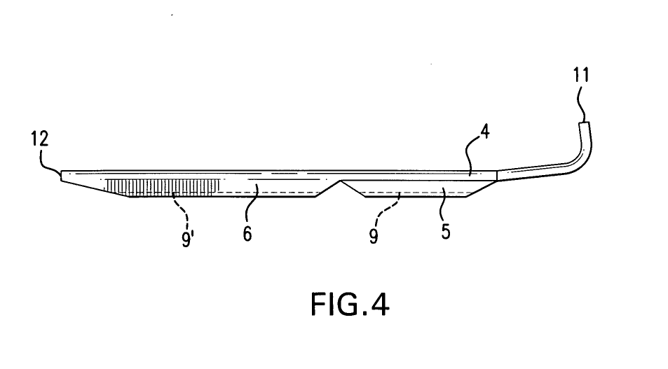

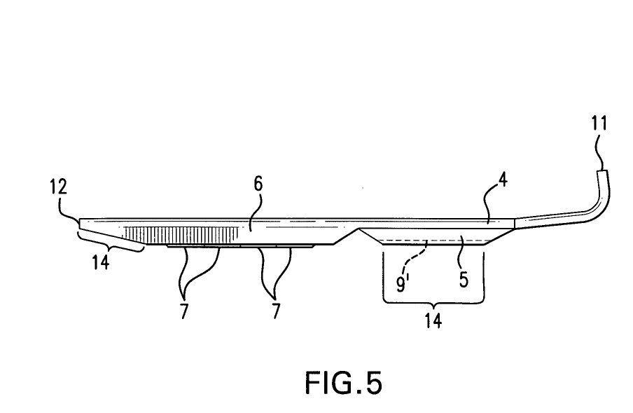

FIG. 4 is a full side view of the shaped metal sheet 13 after the distal end 11 has been bent upwardly in a ski-like form and FIG. 5 shows a full side view of the runner assembly of FIG. 4 with the hardened carbide wear strips 7 are mounted in the groove 9. The distal end 11 is upwardly bent from a position in the plane of the central body 4 to the upturned position as illustrated in FIG. 4.

The carbide wear strips 7 may be metallurgically secured or bonded by brazing or welding to the stock material while still in the sheet form and prior to bending the lateral edges of the downward sheet in opposite directions to form the runners 5 and 6. This invention also contemplates that the carbide strips 7 can be added after the runner portions are bent to the positions shown.

Thereafter, the runners can be treated by one of two methods. The first method is heat treatment. After the carbide wear strips 7 are metallurgically secured in the grooves 9 and 9′, the assembly is quenched in a quenching medium, such as oil, at a predetermined and controlled quench rate to generate a predetermined greater hardness of the workpiece material of between 45 to 65 Rockwell Hardness C to improve the wearability of the runner. A Rockwell hardness C of 45 to 65 is substantially greater than the initial hardness of the sheet metal prior to hardening but still substantially less than the yet greater hardness of the carbide wear strips 7.

The other method does not deal with heat treatment, but instead deals with the use of hard welds 14 that are brazed or welded into the runner edge grooves 9 and 9′, at the predetermined desired locations where they are most effective (See FIGS. 5 and 6) and not in locations where carbide wear strips 7 are located.

The longitudinal grooves 9 and 9′ are provided in this invention to enhance the holding power of the carbide wear strips 7 or the hardened welds 14 in the grooves. Having a configured groove according to this invention allows for more surface area and thus, providing more holding power for the carbide wear strips 7 or the hardened welds 14 thereby preventing or essentially preventing the loss of such carbide wear strips 7 or hardened welds 14 from the runner grooves 9 and 9′ during use.

It should be noted that the runners of this invention are used on the underside of skis that are attached to a snowmobile.

Turning now to the method of fabrication of the runner assembly 1, and with regard to the Figures, the method is generally as follows:

There is provided a single, generally planer sheet of metal material having a predetermined hardness, a generally uniform thickness, upper and lower surfaces, generally free edges the length of the metal material, and longitudinal grooves in the free edges as is set forth in FIG. 1A.

Thereafter, a desired shaped workpiece is cut or stamped from the planer sheet as generally shown in FIG. 2. Thereafter, a predetermined first runner portion and a predetermined second runner portion side regions of the shaped workpiece are bent transversely downwardly out of the plane of the workpiece to extend each runner portion downwardly from laterally opposite sides from the central longitudinally extending base portion of the workpiece such that the first runner portion and second runner portion are not adjacent to each other to from staggered runners. (See FIG. 3A).

Thereafter, mounting portions are formed on the base portion by welding or the like. These mounting portions project upwardly from the top surface of the base portion and it should be noted do not extend into the area between the runner portions.

The hardened carbide wear strips are then securely mounted in the longitudinal grooves as shown in FIG. 5.

At this point in the process, one can elect to provide the heat treatment as described Supra, or can elect to provide hard welds which are also described Supra.

What is claimed is:

1. A traction enhancing runner assembly for mounting on the underside of a snowmobile ski, comprising:
a. a runner body fabricated from a single piece of metal having a predetermined hardness,
said runner body having a central portion with an upper surface, a lower surface, a near end, and a distal end and said central body having integrally attached thereto a transversely downwardly projecting pair of runners which terminate at lower free edges, said pair of runners comprising a first runner and a second runner, said first runner and said second runner having longitudinal grooves the length of the free edges in which carbide wear strips are attached at predetermined locations in the longitudinal grooves;
said first runner and said second runner not being adjacent to each other forming staggered runners;
b. a mounting means secured to and projecting upwardly from said upper surface of said runner body, said mounting means operative to mount said runner on the underside of the snowmobile ski;
said distal end of said runner body being bent upwardly in a ski form.

2. The runner assembly as claimed in claim 2 wherein the longitudinal grooves in the free edges have a V configuration.

3. The runner assembly as claimed in claim 3 wherein the V configuration has a 45° angle.

4. The runner assembly as claimed in claim 2 wherein the longitudinal grooves in the free edges have a square configuration.

5. The runner assembly as claimed in claim 1 wherein the runner body has a flat horizontal plane defined by the upper surface, and the transversely downwardly projecting first runner and second runner are bent downwardly on an angle of from 90° to about 130° of an inside angle □ from the horizontal plane.

6. The runner assembly as claimed in claim 5 wherein the angle □ of the first runner is different than the angle □ of the second runner.

7. The runner assembly as claimed in claim 1 in which the height of the transversely downwardly projecting runners is in the range of about ½ inch to about 1¼ inches.

8. The runner assembly as claimed in claim 1 wherein the mounting means are threaded posts welded to the top surface of the runner body.

9. The runner assembly as claimed in claim 1 wherein the mounting means are threaded bolts through openings in the runner body, wherein the bolt heads are countersunk in the lower surface of the runner body.

10. In combination, a runner of claim 1 and a snowmobile ski wherein the runner is mounted on the underside of the snowmobile ski.

11. In combination, the runner and ski as claimed in claim 10 and a snowmobile, wherein the ski is mounted to the underside of a snowmobile and the runner is mounted on the underside of the ski.

12. A method of fabricating a runner assembly for mounting on the underside of a snowmobile ski, comprising:
I. providing a single, generally planer sheet of metal material having a predetermined hardness, a generally uniform thickness, upper and lower surfaces, generally free edges the length of the metal material, and longitudinal grooves in said free edges;
II. separating a desired shaped workpiece from the planer sheet;
III. bending a predetermined first runner portion and a predetermined second runner portion side regions of the shaped workpiece out of the plane of the workpiece to extend each runner portion downwardly from laterally opposite sides of a central longitudinally extending base portion of the workpiece such that the first runner portion and second runner portion are not adjacent to each other to from staggered runners;
IV. forming mounting portions on the base portion that project upwardly from the top surface of the base portion and which do not extend into the area between the runner portions.

13. A method as claimed in claim 8 wherein, in addition, hardened carbide wear strips are securely mounted in the longitudinal grooves.

14. A method as claimed in claim 11 wherein, in addition, the runner assembly in a step V is heat treated.

15. A method as claimed in claim 11 wherein, in addition, the runner assembly in a step V is not heat treated, but is provided with hardened welds in predetermined locations along the runner lower edge grooves.

14. A traction enhancing runner assembly for mounting on the underside of a snowmobile ski, comprising:
a. a runner body fabricated from a single piece of metal having a predetermined hardness,
said runner body having a central portion with an upper surface, a lower surface, a near end, and a distal end and said central body having integrally attached thereto a transversely downwardly projecting pair of runners which terminate at lower free edges, said pair of runners comprising a first runner and a second runner, said first runner and said second runner having longitudinal grooves the length of the free edges in which carbide wear strips are attached at predetermined locations in the longitudinal grooves;
said first runner and said second runner not being adjacent to each other forming staggered runners;
said first runner and second runner having hardened welds along the free lower edges thereof, at predetermined locations;
b. a mounting means secured to and projecting upwardly from said upper surface of said runner body, said mounting means operative to mount said runner on the underside of the snowmobile ski;
said distal end of said runner body being bent upwardly in a ski form.
